(19) United States
(12) Patent Application Publication
(10) Pub. No.: US 2014/0059623 A1
(43) Pub. Date: Feb. 27, 2014

(54) METHODS AND SYSTEMS FOR PROVIDING PROGRAMMING ON DEMAND TO A SMART DEVICE

(71) Applicant: Hendricks Investment Holdings, LLC, Silver Spring, MD (US)

(72) Inventor: Stephen Ignatius Hasenei, Silver Spring, MD (US)

(21) Appl. No.: 13/968,113

(22) Filed: Aug. 15, 2013

Related U.S. Application Data
(60) Provisional application No. 61/683,577, filed on Aug. 15, 2012.

(51) Int. Cl. H04N 21/414

(52) U.S. Cl. CPC H04N 21/414
USPC 725/85

(57) ABSTRACT

A system and method for obtaining access to multimedia programming transmissions while residing in a temporary dwelling is provided. The temporary dwelling includes a smart docking station in which a smart device may be placed and operably connected. The smart docking station, which houses the smart device, is attached to a server located in a remote geographic location, or in a “cloud.” The smart docking station is operably connected to the remote server wirelessly or via hard wiring, and is able to receive multimedia programming content delivered from content providers. The movie or other multimedia programming may be streamed from a content provider to the smart docking station in the temporary dwelling, via the remote server, to be viewed/listened to on the smart device operably connected to the smart docking station.

### RELATED APPLICATIONS

This application claims the benefit of U.S. Provisional Patent Application No. 61/683,577, titled “Methods and Systems for Providing Programming to a Smart Device, filed Aug. 15, 2012. This application is also related to U.S. Application No. 61/578,686, filed on Dec. 21, 2012, titled “Methods and Systems for Providing Alternative Storage Resources,” which is incorporated herein by reference in its entirety.

### BACKGROUND OF THE INVENTION

1. Field of Invention

Aspects of the present invention relate to methods and systems for providing on-demand multimedia programming transmissions. More particularly, aspects of the present invention relate to providing on-demand multimedia programming transmissions via a smart device.

2. Description of Related Art

Multimedia programming transmissions, which are generally available to users in their private homes, provide users with the ability to select and watch/listen to multimedia programming content on demand. Internet Protocol Television (IPTV) technology is often used to provide multimedia programming transmissions to televisions (TVs) and personal computers. For example, multimedia programming systems for TVs stream content through a set-top box, a computer or other device, allowing users to view/listen in real time or download multimedia programming content to an electronic storage device, such as a computer, digital video recorder, or portable media player for viewing/listening at a later time.

When a user, however, is residing in a temporary dwelling, such as an apartment, vacation home, or hotel room, the user generally has few options available to watch/listen to multimedia programming content such as, for example, movies and music, because multimedia programming transmission options are typically not available in such a temporary setting.

### SUMMARY OF THE INVENTION

In light of the above-described problems and unmet needs, aspects of the present invention provide a system and method for providing owners of temporary dwellings, such as apartments, vacation homes, or hotels, with the ability to provide multimedia programming transmissions to their tenants.

Accordingly, aspects of the present invention provide a system and method for tenants to obtain and pay for access to multimedia programming transmissions while residing in a temporary dwelling.

In accordance with various aspects of the present invention, the temporary dwelling may include a smart docking station in which a smart device such as, for example, a smart telephone, a smart tablet, or a smart board, may be placed and operably connected. The smart device may be the tenant's property or may be the property of the owner of the temporary dwelling. In accordance with various aspects of the present invention, the smart docking station, which houses the smart device, may be attached to a server located in a remote geographic location, or in a “cloud,” if cloud computing is available.

In accordance with various aspect of the present invention, the smart docking station may be operably connected to the remote server, e.g., wirelessly or via hard wiring, and may be able to receive multimedia programming content delivered from content sources such as, for example, movie houses, movie rental companies or other content providers. Accordingly, the movie or other multimedia programming may be streamed from a content provider to the smart docking station in the temporary dwelling, via the remote server, to be viewed/listened to on the smart device operably connected to the smart docking station. Additionally, the smart docking station may be operably connected to an alternative viewing/listening device, such as a TV or a computer, so that the multimedia programming content can be viewed/listened to by the user on the alternative device.

In accordance with various aspects of the present invention, in addition to being a tenant, the user may be the owner of the temporary dwelling or a visitor to the temporary dwelling.

Additional advantages and novel features of these and other aspects of the present invention will be set forth in part in the description that follows, and in part will become more apparent to those skilled in the art upon examination of the following or upon learning by practice thereof.

### BRIEF DESCRIPTION OF THE DRAWINGS

Various example aspects of the systems and methods will be described in detail, with reference to the following figures, wherein:

FIG. 1 is an illustration of a multimedia programming content providing system in accordance with various aspects of the present invention;

FIGS. 2A-2C are illustrations of a coupling mechanism between a smart device and a port, in accordance with various aspects of the present invention;

FIG. 3 is a flow chart illustrating a method of content providing in accordance with various aspects of the present invention;

FIG. 4 presents an example system diagram of various hardware components and other features, for use in accordance with aspects of the present invention; and

FIG. 5 is a block diagram of various example system components, for use in accordance with an aspect of the present invention.

### DETAILED DESCRIPTION

These and other features and advantages in accordance with aspects of this invention are described in, or are apparent from, the following detailed description.

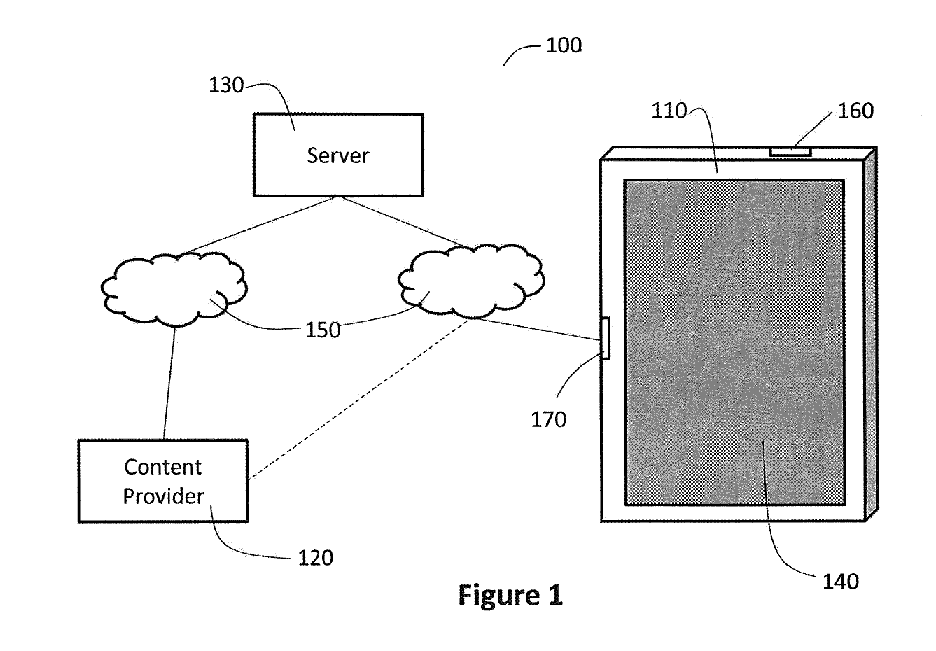

FIG. 1 is an illustration of a multimedia programming content providing system 100 in accordance with various aspects of the present invention. In FIG. 1, the system 100 includes the smart docking station 110 or other receptacle operably connected to the content provider 120 and the server 130. In accordance with various aspects of the present invention, the smart docking station 110, content provider 120, and the server 130 may be operably connected to each other via a computer network, such as, for example, the internet 150. In FIG. 1, in accordance with various aspects of the present invention, a smart device 140 such as a smart telephone, smart tablet, or a smart board may be placed inside the housing of the smart docking station 110 and operably connected to the smart docking station 110, via a power input port and/or a pin connector, in such a way as to be able to access functionality of the smart device 140 via the smart docking station 110, as explained in greater detail in related Patent Application No. 61/578,686. Accordingly, the smart device 140 is remotely and operably connected to the content provider 120 via the smart docking station 110 in order to receive multimedia programming content. The smart device 140 may also be operably connected to the server 130, which may be used to coordinate multimedia programming content from the content provider 120 to the smart device 140. In accordance with various aspects of the present invention, the multimedia programming content may be provided to the smart device 140 from the content provider 120 via the server 130 and the internet 150, or directly from the content provider 120 via the internet 150, as illustrated by the dashed line in FIG. 1.

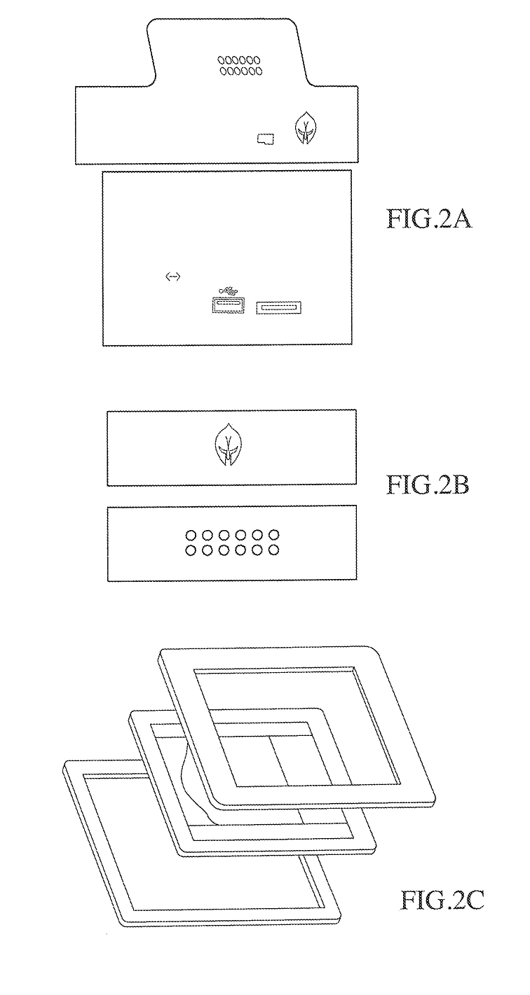

In accordance with various aspects of the present invention, the smart device 140 may be operably connected to the smart docking station 110 via, for example, a high-definition multimedia interface (HDMI) port, a wireless local area network (Wi-Fi) access point, or a universal service bus (USB) port, as illustrated in FIG. 2A. The smart device 140 may also be operably connected to the smart docking station 110 via, for example, a pro:Idiom chip, a high speed bidirectional connection for an HDMI output, a TV/DVR module with cable, satellite or over-the-air connection, or Internet Protocol Television (IPTV), as illustrated in FIG. 2B. Furthermore, the smart device 140 may also be operably connected to the smart docking station 110 via, for example, a smart device enclosure that can be securely connected to the smart device and that localizes programming content and serializes content delivery to the smart device to prevent unauthorized use, as illustrated in FIG. 2C.

In operation, the temporary dwelling may include the smart docking station 110 as part of the rented fixtures. In accordance with various aspects of the present invention, when the tenant occupies the temporary dwelling, the user may operably connect their own smart device 140 with the smart docking station 110 by placing the smart device 140 in the smart docking station 110 and completing the necessary connections, as discussed in related Patent Application No. 61/578,686. Alternatively, the smart device 140 may be the property of the owner of the temporary dwelling, and may already be connected to the smart docking station 110 for the tenant's use.

In accordance with various aspects of the present invention, once the smart docking station 110 is connected to the smart device 140, then a smart device application, such as, for example, an application for a Apple iPad, Apple iPhone, or an Android, may be run on the smart device 140, for example by the tenant, which may identify the smart device either via an identification chip 160 that is part of the smart docking station 110 and that would authenticate the specific smart docking station 110 being used, or via the global positioning system (GPS) location of the smart device 140. Alternatively, identification of the smart docking station 110 may be initiated automatically upon turning on of the smart device 140. In accordance with various aspects of the present invention, the server 130, in communication with the smart docking station 110, may confirm the identification of the smart docking station 110 and the smart device 140, for example, based on the GPS location provided by the smart device 140. Once the smart docking station 110 is authenticated by the server 130, then the user may start choosing a program among a variety of available multimedia programs and displayed on the smart device 140. As an additional option to identifying the GPS location of the smart docking station 110, the GPS location of the smart device 140 may also be identified and authenticated, possibly as an alternative to the identification of the smart docking station 110.

In accordance with various aspects of the present invention, the user, such as a tenant, may run the application on the smart device 140, then choose a multimedia program to view/listen to, and the programming choice of the user may be received by the server 130. When the server 130 receives the program choice, the server 130 may communicate with the content provider 120 to instruct the content provider 120 to provide the content to the smart device 140 via the internet 150. In accordance with various aspects of the present invention, the multimedia programming content may either be communicated directly from the content provider 120 to the smart device 140 via the internet 150, or communicated to the server 130, and then to the smart device 140.

In accordance with various aspects of the present invention, when the user is a tenant of a temporary dwelling, the multimedia programming content may be provided from the content provider 120 to a local server that may be located within close proximity of the temporary dwelling, and the local server may receive and store programming content. Accordingly, when a user orders programming content that is stored on the local server, the user may receive the programming content directly from the local server, e.g., wirelessly or via hard wiring, which may ensure a faster and more secure delivery of the multimedia programming content to the user.

In accordance with various aspects of the present invention, exclusivity and security of the transmission of the multimedia programming content from the content provider 120 and/or the server 130 to the smart device 140 via the internet 150 may be ensured via a decoding chip 170 such as, for example, a pro:Idiom chip, that may be part of the smart docking station 110, as illustrated in FIG. 1, to decode the signal received from the content provider 120 or from the server 130 and to display the received programming content on the smart device 140. In accordance with various aspects of the present invention, the smart docking station 110 may be operably connected wirelessly or via hard wiring to an alternative viewing/listening device, such as a TV or a computer, located in the temporary dwelling in order to display the multimedia programming content provided by the content provider 120 and/or server 130 on the alternative device rather than on the smart device 140, which may provide the user with the ability to watch to the chosen multimedia programming content on a screen larger than the typically smaller screen of a smart device.

Regarding payment for the received programming content, in accordance with various aspects of the present invention, the user may be prompted to provide payment for the chosen program upon selection of the programming content, for example, by entering credit card information or other form of payment directly into the smart device 140, or may be billed at a later time, for example, upon the tenant vacating the temporary dwelling. When the user provides payment for the programming content, the payment may be divided between the content provider 120 and the entity owning and/or managing the server 130.

In accordance with various aspects of the present invention, the entity owning the server 130 may enter into an agreement with the content provider 120, which may be a movie house, an online movie provider, and the like, to distribute multimedia programming content on demand. Also, the owner of one or more temporary dwelling units may purchase a smart docking station 110 for each temporary dwelling unit and may register each smart docking station 110 with the server 130 to match the GPS location of the smart docking station 110 with an identification number of the smart docking station 110 and the registration information being stored at the server 130. The owner of the temporary dwelling may either purchase a smart docking station 110 separately and then register the smart docking station 110 with the server 130, or purchase a preregistered smart docking station 110 from the entity owning and/or managing the server 130.

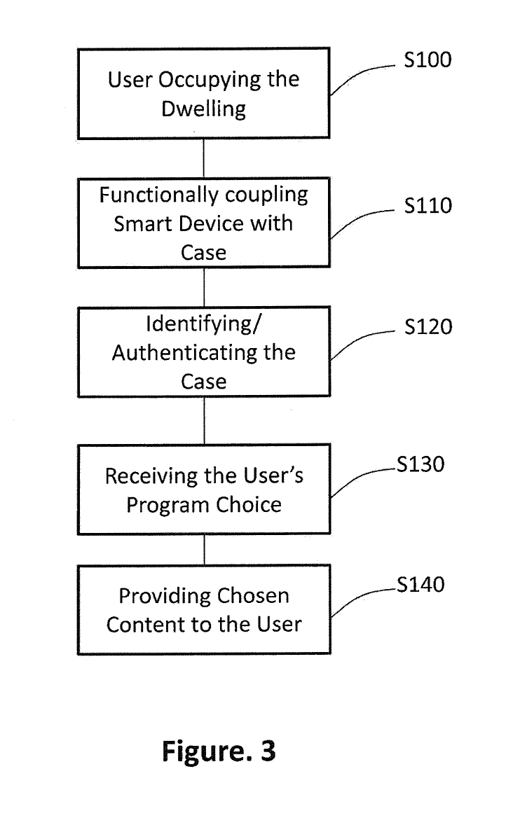

FIG. 3 is a flow chart illustrating a method of content providing in accordance with various aspects of the present invention. In FIG. 3, the method starts at S100, when a user begins to occupy a temporary dwelling. When the user enters the temporary dwelling, the user may operably connect a smart device to the smart docking station at S110. In accordance with various aspects of the present invention, the smart device may be the user's smart device, or may be the property of the owner of the temporary dwelling, in which smart docking station the smart device may already be operably connected to the smart docking station when the user begins occupancy of the temporary dwelling.

In accordance with various aspects of the present invention, when the smart device and the smart docking station are operably connected, the smart docking station may be automatically identified via the GPS location of the smart docking station at S120 when the smart device is turned on, or an application on the smart device may identify the smart docking station at S120. During this step, identification of the smart docking station itself is determined via, for example, an identification chip operably connected to the smart docking station, or an identification number of the smart docking station. Once the identification of the smart docking station is completed, the location of the smart docking station may be determined via, for example, GPS, and the location of the smart docking station may be compared to the identification of the smart docking station to confirm that the correct smart docking station is in the correct location to authenticate the smart docking station. Accordingly, identification and authentication of the smart docking station may be achieved. For example, the server to which the smart docking station is operably connected receives the identification number of the smart docking station and compares the location of the smart docking station and the identification number of the smart docking station to a database that includes a list of identification numbers and their corresponding GPS locations and stored either on the server or remotely from the server. In accordance with various aspects of the present invention, the server may thus determine whether the identification number of the smart docking station corresponds to the GPS location of the smart docking station to conclude whether the smart docking station is in a proper location. If the server determines that the smart docking station is at a proper location, then the server allows the smart docking station, and the smart device operably connected to the smart docking station, to receive programming content from the content provider and/or server. If, however, the server determines that the smart docking station is not at a proper location, then the server may terminate the connection between the smart docking station and the server, inform the content provider of the improper location of the smart docking station, and/or take any other appropriate action to prevent the improperly located smart docking station from being used to receive programming content. Accordingly, if a smart docking station is wrongfully moved to another location, then the smart docking station may become inoperable. As an additional option to identifying the GPS location of the smart docking station, the GPS location of the smart device may also be identified and authenticated, in addition to, or as an alternative to the identification of the smart docking station.

In accordance with various aspects of the present invention, once the smart docking station and/or smart device is properly identified, the user may choose programming content for viewing/listening. To that end, the user may start an application on the smart device, which may initiate the connection between the smart docking station and the content provider via the server, and the user may be provided with a list of all possible programming content available to watch/listen or to be downloaded on a memory of the smart device. Accordingly, at S130 of FIG. 3, the server may receive selection of programming content from the user. In accordance with various aspects of the present invention, if payment is required at that time, then the user may be prompted to enter payment information, otherwise the user may receive a bill at a later time. Once the selection from the user has been received by the server at S130, then the server communicates with the content provider to have the content provider provide the chosen programming content to the user, for example, via a network or the internet, at S140. When the programming content is received at the smart device via the smart docking station, the user is then able to view/listen to the programming content. Alternatively, the user may view/listen to the chosen programming content on an alternative viewing/listening device, such as a TV, located in the temporary dwelling via a connection and/or coupling between the smart device and the alternative device, which may provide the user with a larger viewing screen than that of a smart device.

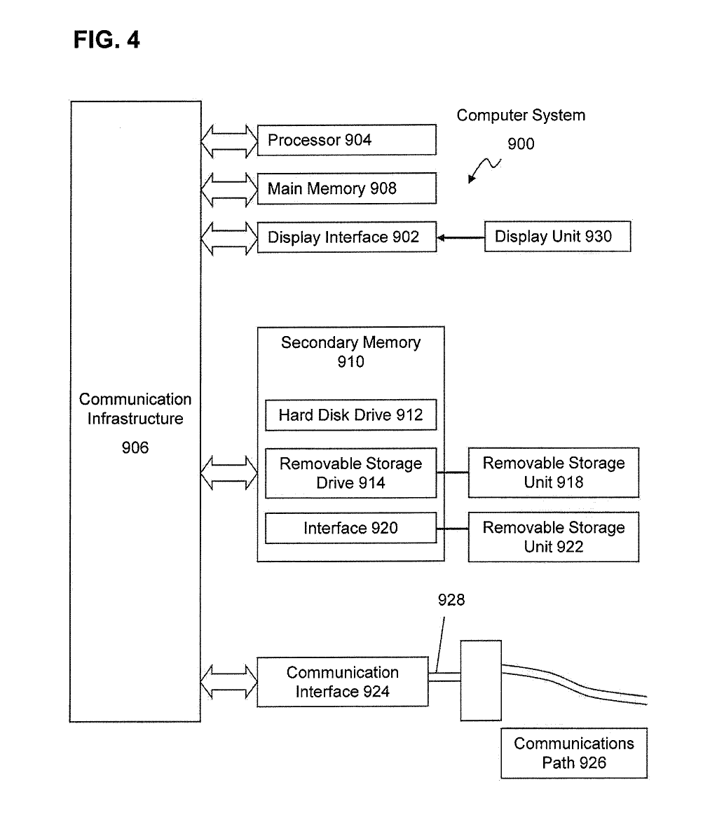

FIG. 4 presents an example system diagram of various hardware components and other features, for use in accordance with an aspect of the present invention. Aspects of the present invention may be implemented using hardware, software, or a combination thereof and may be implemented in one or more computer systems or other processing systems. In one variation, aspects of the present invention are directed toward one or more computer systems capable of carrying out the functionality described herein. An example of such a computer system 900 is shown in FIG. 4.

Computer system 900 includes one or more processors, such as processor 904.—The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement aspects of the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data. In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 914, a hard disk installed in hard disk drive 912, and signals 928. These computer program products provide software to the computer system 900. Aspects of the invention are directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features in accordance with aspects of the present invention, as discussed herein. In particular, the computer programs, when executed, enable the processor 904 to perform the features in accordance with aspects of the present invention. Accordingly, such computer programs represent controllers of the computer system 900.

In an example variation where aspects of the present invention are implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another example variation, aspects of the present invention are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the present invention are implemented using a combination of both hardware and software.

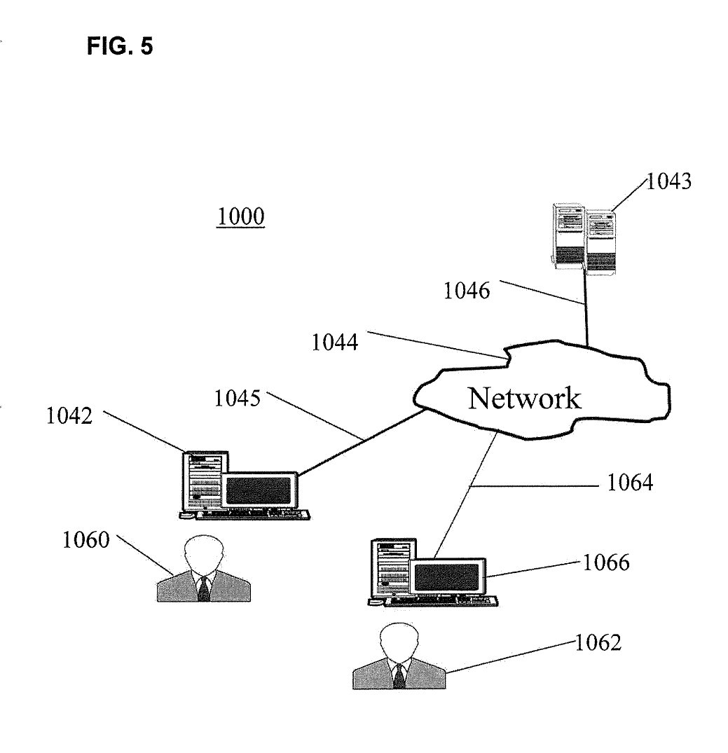

FIG. 5 is a block diagram of various example system components, in accordance with an aspect of the present invention. FIG. 5 shows a communication system 1000 usable in accordance with the present invention. The communication system 1000 includes one or more accessors 1060, 1062 (also referred to interchangeably herein as one or more “users”) and one or more terminals 1042, 1066, each of the terminals 1042, 1066 including, for example, a reading device and an operably connected smart docking station. In one aspect, data for use in accordance with the present invention is, for example, input and/or accessed by accessors 1060, 1062 occurs via terminals 1042, 1066, wherein the reading device includes a personal computer (PC), a minicomputer, mainframe computer, microcomputer, telephonic device, or wireless device, such as a personal digital assistant (“PDA”) or other hand-held wireless device. Data accessed may be located at a server 1043, such as a PC, minicomputer, mainframe computer, microcomputer, or other device having a processor and a repository for data and/or connection to a repository for data, via, for example, a network 1044, such as the internet or an intranet, and access via the terminals 1042, 1066 may occur via couplings 1045, 1046, 1064. The couplings 1045, 1046 and 1064 include, for example, wired, wireless, or fiber-optic links. In another aspect, the method and system of the present invention operate in a stand-alone environment, such as on a single terminal.

While aspects of this invention have been described in conjunction with the example features outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and thereof. Therefore, aspects of the invention are intended to embrace all known or later-developed alternatives, modifications, variations, improvements, and/or substantial equivalents.

What is claimed is:

1. A smart docking station device comprising:
a housing that receives at least one engaged device;
a coupling port in the housing that couples to the engaged device; and
an interface port that enables coupling of the engaged device to at least one server.

2. The device of claim 1, wherein the engaged device comprises at least one smart device.

3. The device of claim 2, wherein the smart device is a terminal.

4. The device of claim 3, wherein the terminal is selected from a group consisting of a personal computer, a minicomputer, a mainframe computer, a microcomputer, a hand-held device, and a telephonic device.

5. The device of claim 2, wherein the smart device comprises at least one selecting from a group consisting of a smart telephone, a smart tablet, and a smart board.

6. The device of claim 1, wherein the coupling port comprises at least one selected from a group consisting of a power input port and a pin connector for the engaged device.

7. The device of claim 1, wherein the interface port comprises at least one selected from a group consisting of a high-definition multimedia interface (HDMI) port, a wireless local area network (Wi-Fi) access point, and a universal service bus (USB) port.

8. The device of claim 1, wherein the smart docking station device comprises at least one port for coupling at least one alternative terminal.

9. The device of claim 8, wherein the alternative terminal comprises of at least one selected from a group consisting of a television and a computer.

10. The device of claim 1, wherein the smart docking station device comprises at least one identification module.

11. The device of claim 10, wherein the identification module is configured to authenticate the smart docking station device.

12. The device of claim 10, wherein the identification module is configured to verify the geographic location of the smart docking station device.

13. The device of claim 1, wherein the smart docking station device comprises at least one decoding module.

14. The device of claim 13, wherein the decoding module is configured to decode programming content received by the smart docking station device via the at least one server.

15. A system for providing multimedia programming content to an engaged device, the system comprising:
a smart docking station device with which at least one engaged device may be coupled via a coupling port;
a communications module configured to communicate with the engaged device; and
an interface module configured to communicate with at least one server;
wherein the engaged device is configured to receive multimedia programming content from the at least one server via the smart docking station device.

16. The system of claim 15, wherein the smart docking station device is configured to receive at least one engaged device.

17. The system of claim 16, wherein an access port for coupling of at least one engaged device is contained within the smart docking station device.

18. The system of claim 15, wherein the engaged device comprises at least one smart device.

19. The system of claim 18, wherein the smart device comprises of at least one selected from a group consisting of a smart telephone, a smart tablet, and a smart board.

20. The system of claim 15, wherein the smart device comprises a terminal.

21. The system of claim 20, wherein the terminal is selected from a group consisting of a personal computer, a minicomputer, a mainframe computer, a microcomputer, a hand-held device, and a telephonic device.

22. The system of claim 15, wherein the coupling port comprises at least one selected from a group consisting of a power input port for the engaged device and a pin connector for the engaged device.

23. The system of claim 15, wherein the interface module comprises at least one selected from a group of a HDMI port, a Wi-Fi access point, and a USB port.

24. The system of claim 15, wherein the smart docking station device is coupled to at the least one server via a network.

25. The system of claim 24, wherein the network is selected from a group consisting of a cable network, a wireless network, and the internet.

26. The system of claim 15, wherein the smart docking station device comprises at least one port for coupling at least one alternative terminal.

27. The system of claim 26, wherein the alternative terminal comprises of at least one selected from a group consisting of a television and a computer.

28. The system of claim 15, wherein each of the at least one server is selected from a group consisting of a personal computer, a minicomputer, a microcomputer, and a mainframe computer.

29. A computer-implemented method of providing multimedia programming content to an engaged device via a smart docking station device coupled to at least one server, the method comprising:
coupling at least one engaged device to the smart docking station device, the smart docking station device receiving a request for programming content via the at least one engaged device;
authenticating the identity of the smart docking station device via an identification module;
verifying the geographic location of the smart docking station device via a decoding module; and
receiving programming content via the least one engaged device.

30. The method of claim 29, wherein the engaged device comprises at least one smart device.

31. The method of claim 30, wherein the smart device comprises at least one selected from a group consisting of a smart telephone, a smart tablet, and a smart board.

32. The method of claim 29, further comprising paying for the received programming content via the engaged device coupled to the smart docking station device.

33. The method of claim 29, wherein the identification module is configured to verify the geographic location of the smart docking station device.

34. The method of claim 29, wherein the decoding module is configured to decode programming content received by the smart docking station device via the at least one server.
